(19) United States
(12) Patent Application Publication
(10) Pub. No.: US 2006/0003300 A1
(43) Pub. Date: Jan. 5, 2006

(54) Method and apparatus for creating a personal sports lesson

(75) Inventor: Thomas Allen Davis, Palm Harbor, FL (US)

Correspondence Address: BAKER & MCKENZIE LLP, 805 THIRD AVENUE - 29TH FLOOR, NEW YORK, NY, 10022, US

(73) Assignee: Interactive Sports Training, LLC (formerly known as Major League Partners), Clearwater, FL (US)

(21) Appl. No.: 11/064,408

(22) Filed: Feb. 22, 2005

Related U.S. Application Data
(60) Provisional application No. 60/584,051, filed on Jun. 30, 2004.

(51) Int. Cl. G09B 19/00; A63B 69/00

(52) U.S. Cl. 434/247

(57) ABSTRACT

A system and method for creating a personal sports lesson captures video file of a sport motion of a person, for instance a baseball batting swing from start to finish. Various part of the body positions are marked in each of the selected video swing frames and analyzed against a knowledge base and those of a professional player for providing an interactive personal lesson.

### CROSS-REFERENCE TO RELATED APPLICATIONS

This application claims the benefit of U.S. Provisional Patent Application No. 60/584,051 entitled, “Method and System for Creating a Personal Sports Lesson from a Video,” filed on Jun. 30, 2004, which application is incorporated herein by reference in its entirety. The present application is related to U.S. Pat. No. 5,797,805 and U.S. Pat. No. 6,068,559.

### TECHNICAL FIELD

This application relates generally to instructional systems for teaching sports activities, and particularly to creating a personalized baseball batting lesson that takes into account an individual's body form and positions.

### BACKGROUND

In any sports, proper body forms and positions are important factors for success. In baseball, for instance, a proper swing of the bat requires maintaining a good position of the head, hands, and feet in relation to the body throughout the various parts of the swing. Learning systems have been proposed that record a player's swing and analyze the swing according to general predetermined principles.

Naturally, however, a best way to learn and practice is under the direction of a professional player and personal supervision. For example, it would be desirable to have a professional player watch and critique the swing and provide individualized feedback on aspects of the swing, and at the same time show the proper motions all in the convenience of one's own settings, such as one's home.

Thus, a system is needed for providing an interactive lesson that analyzes a person's swing and critiques the motions, while at the same time demonstrating the fundamental moves as well as allowing the person to view the swing in synchronization, preferably with that of a professional player.

### SUMMARY

A system and method for producing a personal lesson from a visual recording of a person's sports motion is disclosed. The system in one aspect includes a video capture module operable to receive transmission signals representing sports movement of a person and to present the transmission signals to a user as a plurality of still frames playable by the user. The video capture module is further operable to receive input information from the user, the input information being used to process the plurality of still frames.

A training module is operable to receive from the user a plurality of selected still frames from the plurality of still frames and a plurality of location coordinates on one or more of the plurality of selected still frames. The training module is further operable to receive motion information about the selected still frames from the user, the training module performing sports analysis using the plurality of location coordinates and the motion information. A lesson module is operable to provide an interactive sports lesson based on the sports analysis.

In another aspect, the method includes receiving transmission signals representing sports movements of a person and presenting the transmission signals to a user as a plurality of still frames. The method also includes receiving a plurality of selected still frames from the plurality of still frames, receiving one or more location coordinates in each of the plurality of selected still frames, and receiving motion information pertaining to the plurality of selected still frames. The method further includes performing sports analysis based on the one or more location coordinates, the motion information, and pre-stored knowledge bank. Still yet, the method includes providing an interactive lesson using the sports analysis.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram of the system in one embodiment.

FIG. 2 is a screen shot presented to the user for preparing the swing video.

FIG. 3 is a flow diagram illustrating the method for the video wizard in one embodiment.

FIG. 4 is a flow diagram illustrating the method for the training wizard that guides a user through a series of questions, answers to which are used to formulate a personalized lesson in one embodiment.

FIG. 5A is an example screen shot that is presented to a user at the start of the training wizard.

FIG. 5B is another example of a screen shot presented to a user, for instance, for asking the user to input the length of the player's lower leg.

FIG. 5C is an example of a screen shot that prompts the user to locate a frame that shows a stance position.

FIG. 5D is an example screen that instructs the user to click on parts of the body on the video frame.

FIG. 5E is an example screen through which the training wizard gathers more information from the user.

FIG. 6 is a flow diagram illustrating the method for providing an interactive lesson in one embodiment.

FIG. 7 is an example screen shot presented during an interactive lesson in one embodiment.

FIG. 8 is a network diagram that illustrates an example topology for the system and method disclosed.

FIG. 9 is a screen shot that illustrates an example report.

FIG. 10 is a screen shot that shows an example of side-by-side synchronized positions of an amateur player and a professional player.

### DETAILED DESCRIPTION

A system and method for producing a personal lesson from a visual recording of a person's sports motion allows any person having no specialized knowledge or training in the sport to be able to produce an individualized lesson. The individualized lesson provides relevant feedback on aspects of the person's sports motion, in the form of audio or text. Additionally, the system and method allows any person to compare their sports motion in a side-by-side visual display with the pre-recorded sports motions of other persons. For instance, the sports motions of each person displayed are synchronized through the key positions of their respective motions.

In one embodiment, a visual recording of a person's sports motion is converted into a specific digital format which embeds selected user data into a file so that it may be incorporated into and read for display and interaction on the user's computer. The system and method provides the user with a simple, step-by-step help wizard process, which guides the user through a series of prompts and carefully designed questions, which relate to the sports motion being analyzed. The questions are specifically designed to allow any user having no specialized knowledge in the sport to be able to provide sufficiently accurate responses so as to allow the software to create an accurate, personalized lesson.

The system and method in one embodiment prompts the user to visually locate specific video frames of the visual recording using the player controls, while displaying help information in the form of a sample image and descriptive text. Once the user has selected the video frame of their choosing, the system and method in one embodiment stores this frame number in file, for example. The system and method then prompts the user to use their input device, such as a mouse pointer device, to click on specific coordinates of the video display, while displaying help information in the form of a sample image and descriptive text.

Once the user has chosen and selected the coordinate on the video display, the system and method in one embodiment stores the coordinate in a file. The system and method then prompts the user with questions about what they observe about certain aspects of the sports motion on the video display, and the user is asked to select the most appropriate answer, based on what they observe, from a list of possible answers displayed on the screen. Once the user has selected an answer to the question, the software stores this answer, for example, in a file. This process is repeated for any number of video frames necessary in order to store sufficient relevant data of the sports motion being analyzed to produce an individualized, personal lesson.

The system and method prompts the user to input the measured distance of the lower leg of the person performing the sports motion in the visual recording, from the center of their kneecap to the sole of their shoe. Once the user has entered this measured value, the system and method stores this value, for example, into a file.

The system and method parses the data stored, for example, in the file(s), performs calculations, and stores the resultant data in lesson file(s), which contain information specific to that person's sports motion.

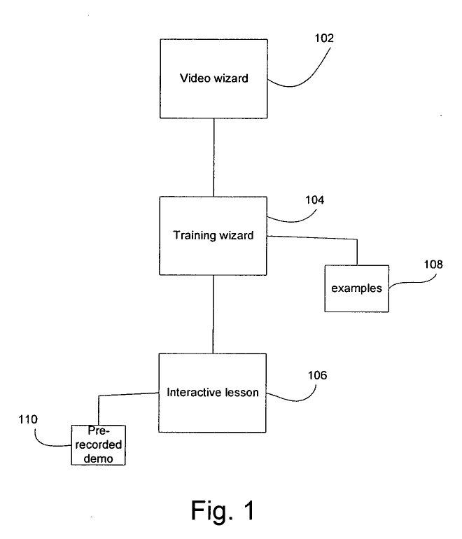

FIG. 1 is a block diagram of the system in one embodiment. Although the example described in the present application pertains to creating a baseball batting lesson, a person of ordinary skill in the art will appreciate that it is possible to create lessons for other sports that have similar motion requirements. In one embodiment, the system comprises a video wizard 102, a training wizard 104, and an interactive lesson component 106. The video wizard 104 and the training wizard 106 are modules or software components that capture a person's swing and prepare it for a personal lesson. An interactive lesson component 106 then provides an interactive lesson to the user, for example, using a pre-recorded professional lesson demonstrations and drill 110 along with the personalized lesson prepared by the training wizard 104. The video and training wizards 102, 104 guide a user through a series of questions, providing visual cues to aid and make it easier for user to answer the questions. For instance, the training wizard uses a side-by-side display of a pre-recorded professional player's positions 108 as examples.

The video wizard allows a user to use a video file that is already stored on a computer, capture from a prerecorded tape or video file, or capture the swing in real-time using a camera connected to a computer. If the user selects to use a video file that is already stored on a computer, the module prompts the user for the location of the file. Alternatively, a video file that is stored on videotape or other storage medium may be used by connecting a device that reads the medium to the computer and transferring the file to the computer. Still yet as another example, a swing may be filmed using a camera connected to a computer and the data representing the swing captured directly and stored in the computer. In this third example, a user can see the swing on the computer monitor as it is being captured. Although a user may film the swing by holding a camera in a conventional manner, a camera mounted on a tripod may provide a more stable picture.

A captured swing, for example, a baseball swing, includes a moving view of an entire swing across from the home plate, from start to finish, a person's entire body, and the entire bat from start to finish. The moving view is comprised of a series of video frames from start to finish.

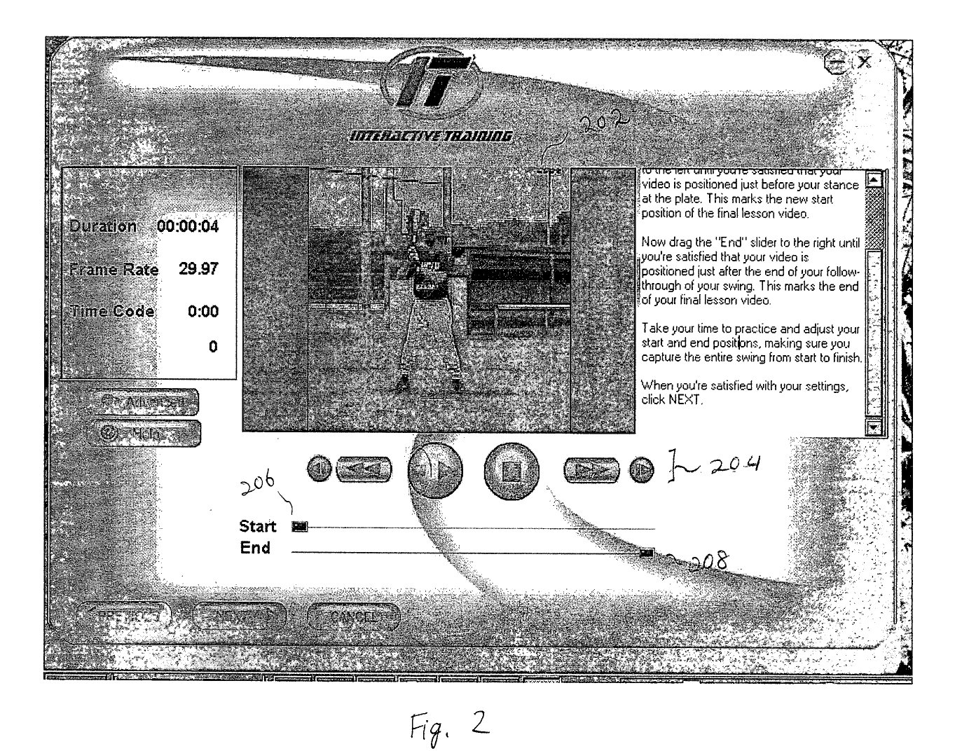

Once a person's swing is captured, the video wizard prepares the video into an optimal format for processing. For instance the video wizard displays the captured swing and allows a user to crop extraneous frames from the beginning or the end of the swing video. FIG. 2 is a screen shot presented to the user for preparing the swing video. Using the buttons 204, a user may replay the captured video 202 in a normal, slow or fast speed, rewind or forward frame by frame, or pause. The video may be cropped using a start slider 206 and an end slider 208 to mark the beginning and end of the video. For example, a user may glide the start slider 206 at a point or frame that shows the person's position just before the stance at the plate. This frame would mark the new start position for a lesson video. Similarly, gliding the end slider 208 to a video frame displaying the person's position just after the end of the follow through of the swing would mark the end of a lesson video.

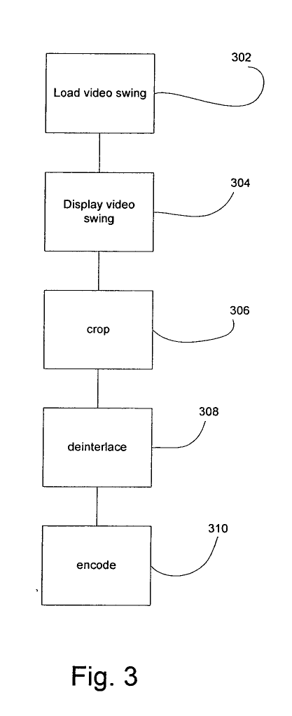

FIG. 3 is a flow diagram illustrating a method for the video wizard in one embodiment. At 302, a swing video specified by the user is loaded. At 304, the video wizard presents a view, for example, shown and described with reference to FIG. 2, to prepare the swing video for a lesson. The video wizard then receives the user inputs, for instance, the new start and end positions that the user marked, and processes the swing video. For example, at 306, the video wizard deletes the video frames that appear before the new start position and those that are after the new end position.

At 308, if the captured video is interlaced, the swing video is deinterlaced, for instance, for proper and smooth display on the computer monitor. Deinterlacing, for instance, provides a clearer picture when the video swing is shown in slow motion or as a still frame. Briefly, deinterlacing retrieves a prior still frame and uses the prior still frame's lines to fill in the interlaced missing lines in the current frame. Deinterlacing is widely known to a person having ordinary skill in this technology, and therefore, will not be described in detail here.

At 310, the video wizard encodes the cropped and deinterlaced swing video into a proper format for playing on a desired media and device. Video encoding, for instance, as known to those skilled in the technology, compresses captured video swing's raw data into a manageable format for display or presentation on a desired media device or program. In one embodiment, the video swing is captured in a raw AVI format and encoded into an SWF format. The modules in the present application may utilize any graphics animations programs for implementation. Macromedia Flash is one example of a graphics animations program that uses vector graphics. The video swing file can thus be converted to an SWF file for the Macromedia Flash to handle.

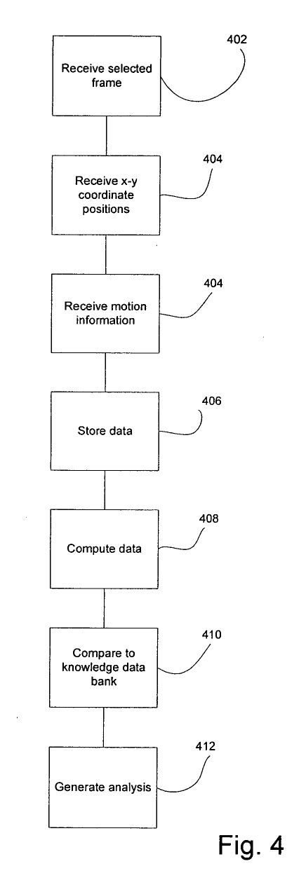

After the video wizard prepares the video swing, the training wizard of the present application in one embodiment presents a series of questions and instructions for marking the player's coordinates on the swing video for creating a personalized lesson. FIG. 4 is a flow diagram illustrating the method for the training wizard that guides a user through a series of questions, answers to which are used to formulate a personalized lesson in one embodiment. At 402, through a series of visually aided questions, the training wizard gathers data from a user, for instance, by asking to select one or more still frames, to click on various body parts and equipment at 404, and to answer a number of questions at 406 about the player's motion as presented on the still frames.

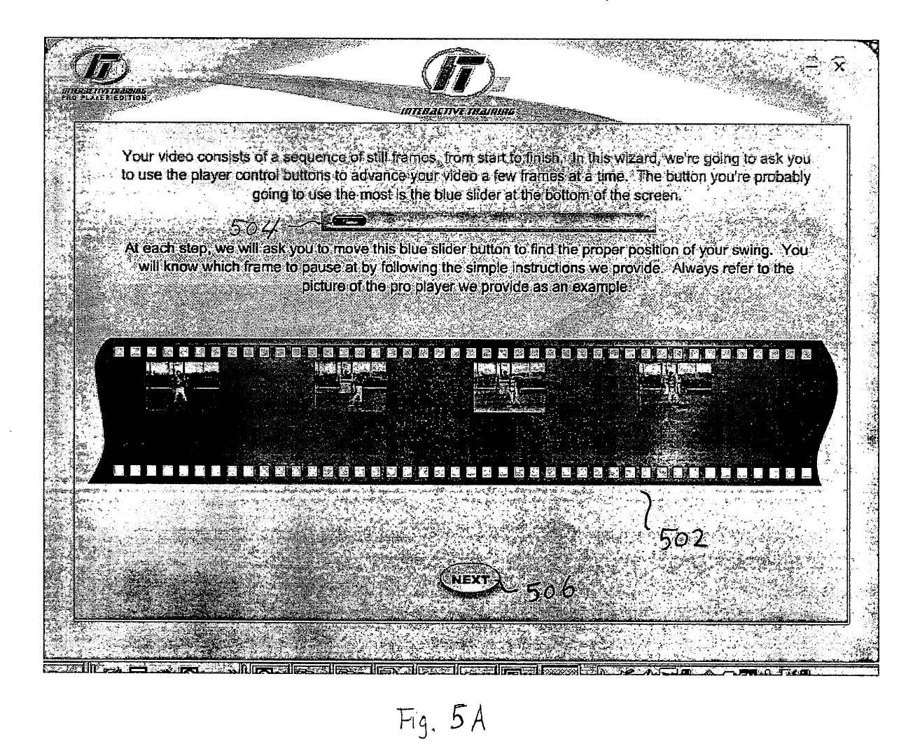

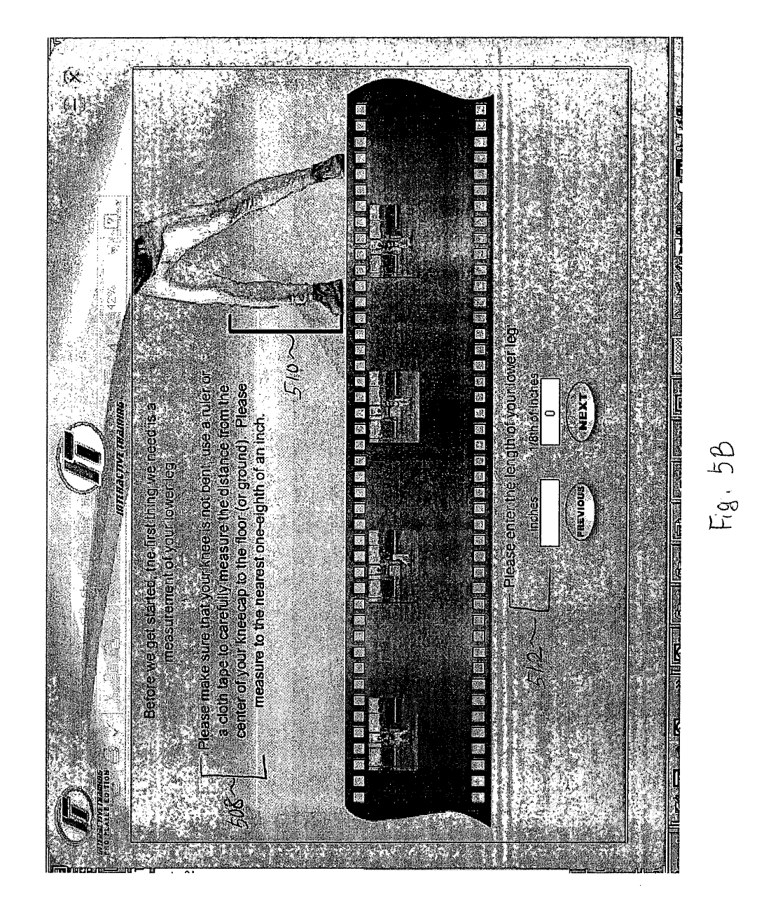

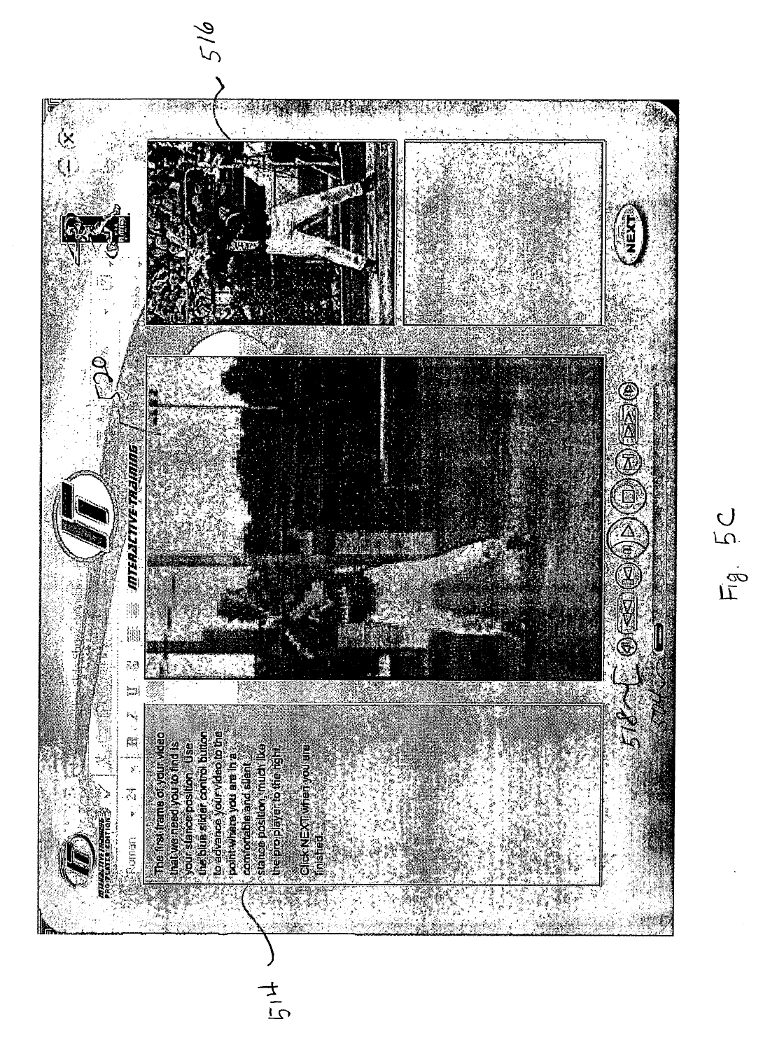

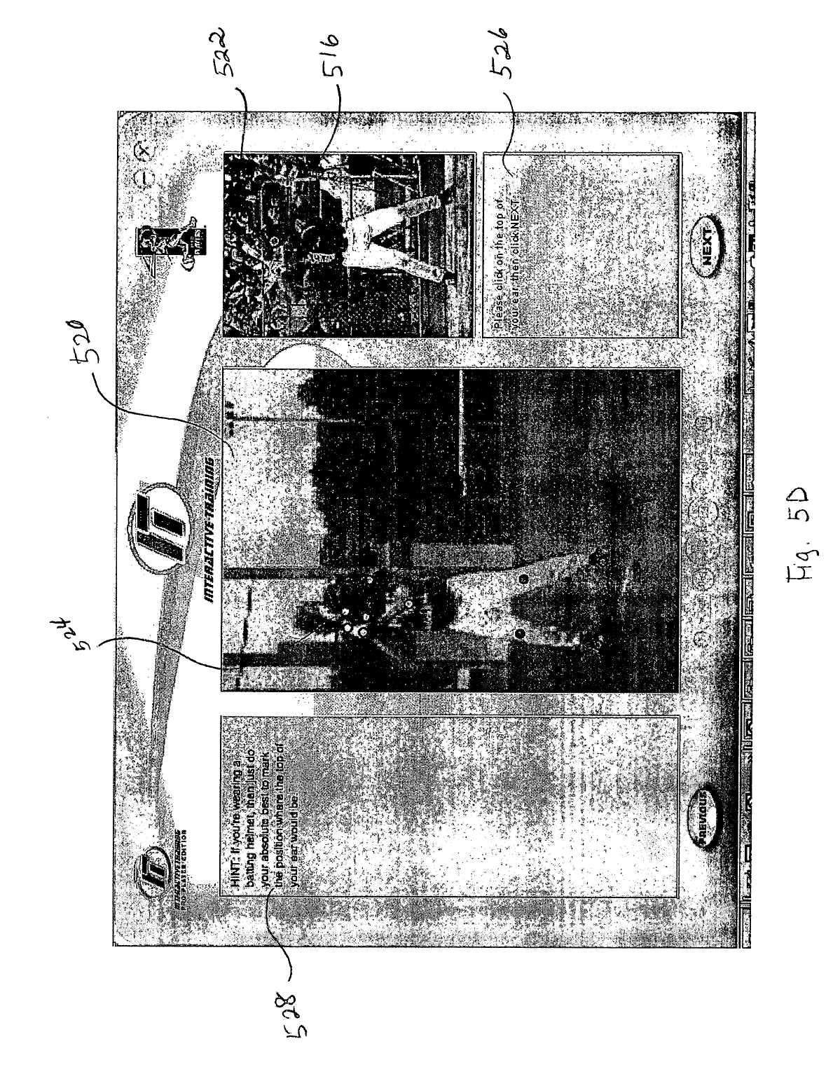

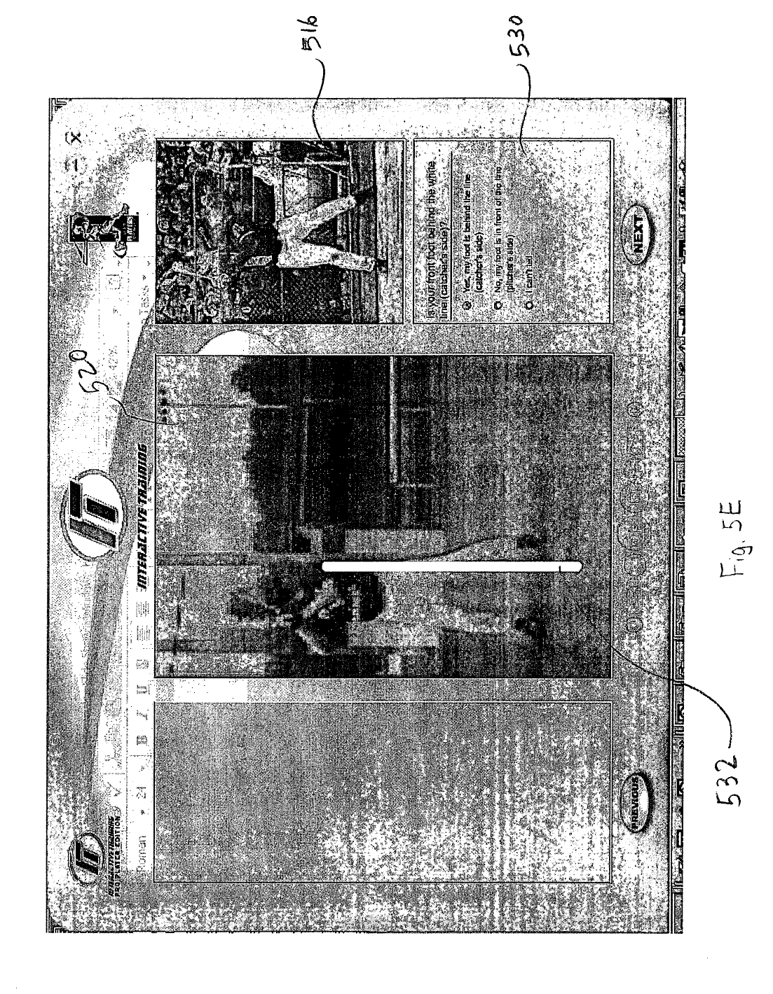

FIG. 5A is an example screen shot that is presented to a user at the start of the training wizard. The swing video comprises of sequence of still frames 502, from start to finish. The training wizard allows the user to use a control button 504 that can be glided back and forth, for instance, to locate a frame with a desired swing position. To continue with the training wizard, the user clicks on the “next” button 506.

FIG. 5B is another example of a screen shot presented to a user, for instance, for asking the user to input the length of the player's lower leg. As shown, in addition to a voice prompt that asks the user to enter the data, the user is provided with a textual explanation 508 as well as a visual aid 510 for entering the requested information 512.

Stepping the user through additional series of screens, the training wizard gathers information needed to build a personalized lesson. For instance, the training wizard prompts the user to select frames in the swing video that shows the stance position, the completion of a trigger (a player's trigger is the point where the player's hands have moved the farthest back towards the catcher, but before the hands have begun to move forward as the player swing), where the bat hits the ball, the frame where the bat is pointing out to the pitcher's mound during the follow through after making contact with the ball, etc.

FIG. 5C is an example of a screen shot that prompts the user to locate a frame that shows a stance position. The captured swing video 520 is shown from start to finish. As in the previous screens, a voice prompt as well as a text prompt 514 on the screen provides instructions to the user. A side-by-side picture 516 of a professional player in the desired position makes it easier for the user to select a correct frame. The buttons 518 allow a user to play, fast forward, rewind, or advance or reverse the video 520 to the next or previous frame. In addition, a slider 504 may be used to advance or reverse the video 520.

After the user selects a frame that shows the requested position, the training wizard directs the user to click on various parts of the player's body and equipment (such as a baseball bat) positions. FIG. 5D is an example screen that instructs the user to click on various parts of the body on the video frame 520. In this screen, for example, the user is prompted to click on the top of the player's ear as shown at 526. As a reference point, a side-by-side picture 516 shows a professional player with his ear marked as a circular dot 522. This way, the user knows exactly the part of the body the user is being asked to click. When the user points his input device such as the mouse on the player's ear and clicks, an indicator such as a circular dot 524 appears on the screen. Other parts of the player's body where the user has already clicked, in response to the previous prompts, are also shown as circular dots on the screen. These parts, for instance, include the feet, knees, elbow, hands, shoulder, and the point where the hands meet the bat, etc. In addition, the training wizard may provide a helpful hint as shown at 528 to further clarify and aid the user.

In one embodiment, an invisible graphics overlay having x-y coordinates is used on top of the still frame to read the coordinate position of the clicked body parts. The input positions then are stored, for example, in an XML file for analysis. Briefly, XML (Extensible Markup Language) is a flexible way to create common information formats and share both the format and the data on the World Wide Web, intranets, and elsewhere. For example, computer makers might agree on a standard or common way to describe the information about a computer product (processor speed, memory size, and so forth) and then describe the product information format with XML. Such a standard way of describing data would enable a user to send an intelligent agent (for example, a program) to each computer maker's Web site, gather data, and then make a valid comparison. XML can be used by any individual or group of individuals or companies that wants to share information in a consistent way.

As will be explained below, the x-y coordinates are used to calculate the player's motions for analysis and also to place telestrations on the frames. For example, the x-y coordinate corresponding to the location of the player's knee may be used to telestrate a circle around the player's knee.

The training wizard also asks a series of questions about the body position shown in the selected frame 520. FIG. 5E is an example screen through which the training wizard gathers more information from the user. The questions are typically in the multiple-choice format as shown at 530, for instance, so that all the user needs to do is click on the possible answer. Again, a side-by-side picture of a professional player 516 is shown as a reference to aid the user in answering the questions. A telestration 532 may be drawn to further help the user answer some questions.

In an embodiment of the present application, the questions may be stored in a file in XML format. The file in XML format that stores the questions may contain, for example, a plurality of sections corresponding to positions including stance, stride, trigger, etc., and each section may contain a plurality of questions. Sections corresponding to each of the plurality of questions may contain a plurality of possible answers as described above. An example of a file in XML format for storing questions according to an embodiment of the present application is provided in the appendix attached hereto and entitled “Question.xml”. Additionally, information associated with responses provided by the user may be stored in a summary output file in XML format, an example of which is provided in the appendix attached hereto and entitled “SummaryOutput.xml”.

Referring back to FIG. 4, once the data is gathered, for instance, data such as the location of the body parts as clicked by the user on the video swing frame overlay and answers to questions pertaining to each of the body position frames, the training wizard stores and analyzes the data for preparing a personalized lesson. For instance, at 406, the training wizard stores the input data in an XML file.

For example, according to an embodiment of the present application, the file in XML format that stores the input data may contain fields corresponding to each body position frame. The fields may contain information, for example, associated with the data points created by the user for each body position frame. For example, each section of the file in XML format that stores input data may contain information corresponding to a stance frame, a stride frame, etc., and each section may contain data that indicate a frame number and a number of data points. Each data point may be assigned a unique name and coordinates, the coordinates for example corresponding to “x” and “y” values for each data point. The “x” and “y” values may each be measured with reference to an origin located at an upper left corner of the frame. An example of a file in XML format that stores the input data points according to an embodiment of the present application is provided in the appendix attached hereto and entitled “TelestrationOutput.xml”. Additionally, data corresponding to responses to the questions and to the data points selected by the user may be stored in a file in XML format. An example of a file in XML format that stores the responses and selected data points is provided in the appendix attached hereto and entitled “KFEWizardOutput.xml”.

At 408, comparing the location coordinates of body parts from one position to another, the training wizard evaluates the movements, how far a body part moved or stayed from one position to another, whether hand positions are smooth, etc. For instance, the training wizard calculates the difference in the position coordinates of a player's foot location in a stance still frame and a stride still frame to evaluate the movement of the foot. This type of calculation is performed on the data stored for the various parts of the body as well as the bat.

The training wizard then uses the calculated data and the answers to the questions to analyze the movement, distance, angle of the movement, and any other data as needed for a personalized lesson. For instance, at 408, the player's data is compared to a knowledge bank data that includes the proper positions, movements, etc. The knowledge bank includes, for example, data positions and movement conditions of how a proper bat swing should be.

Thus, for example, if it is determined that the player's hand position moved 20 degrees forward from one position to another, and the knowledge bank data indicates that the proper movement of the hand in the corresponding position should be within 18-22 degrees, the training wizard automatically determines that the player did well in this particular position movement. On the other hand, if the player's movement is outside the range in the knowledge data bank, the training wizard automatically determines improvements and suggestions as indicated in the knowledge bank. Thus, in one embodiment, the analysis includes using the data points, which the user indicated on the selected frames and answers to the questions, in conjunction with the internal rules and predetermined variances from the rules.

Additionally, in an exemplary embodiment, analysis may be performed at various points during a swing movement of a subject. The analysis may be performed on one or more swing positions and may be performed in any sequence. Based upon the analysis, the position and/or performance of the subject at each analyzed position during the swing may be assigned a “pass” or a “fail” status.

For example, in a first position, the analysis may include determining whether the subject's feet are approximately shoulder-width apart, by determining a distance between the insides of the subject's feet and a distance across the subject's shoulders. The distances may then be compared. A “pass” status may be assigned when the analysis determines that a difference between the distances is within a predetermined value, for example, approximately two inches. A “fail” status may be assigned when the difference between the distances is determined to be more than, for example, approximately two inches.

The analysis of the first position may further include determining whether the subject's knees are aligned approximately with the inside of the subject's feet, by comparing a position of the subject's kneecaps with the position of the insides of the subject's feet. A “pass” status may be assigned when the analysis determines that the subject's knees are approximately aligned with the inside of the subject's feet within a predetermined alignment, for example approximately two inches. A “fail” status may be assigned when the subject's knees and feet are out of alignment by more than, for example, approximately two inches.

The analysis of the first position may further include determining a height of the front and back shoulders by measuring an angle of a line drawn across a top of the shoulders. A “pass” status may be assigned when the shoulders are determined to be in alignment within a predetermined difference, for example within approximately eight degrees. A “fail” status may be assigned when the angle of the line with respect to horizontal is greater than, for example, approximately eight degrees.

Analysis of the first position may additionally include a determination of whether a thumb of a top hand is between a shoulder and a top of an ear of the subject, by comparing a height of a top of the upper hand on the bat with a height of a bottom of the ear and a top of the shoulder. A “pass” status may be assigned when the thumb of the top hand is determined to be between the shoulder and the top of the ear. A “fail” status may be assigned when the thumb of the top hand is determined to not be between the shoulder and the top of the ear.

In a second position, analysis may be performed to determine if a back elbow is no more than approximately four inches higher than a front elbow, by measuring a difference between a height of a tip of the rear elbow and a height of a tip of the front elbow. A “pass” status may be assigned when the rear elbow is, for example, higher than the front elbow by approximately four inches or less. A “pass” status may also be assigned when the rear elbow is lower than the front elbow.

Additionally, analysis of the second position may include determining whether the hands have moved back approximately 1.5 inches, but not more than approximately four inches relative to the initial stance position by comparing where the hands meet on the bat, and a “pass” status or a “fail” status may be assigned based upon the relative movement of the hands. For example, a “pass” status may be assigned when the hands have moved between approximately 1.5 inches and approximately four inches back from the initial stance, while movement of more than approximately four inches may be assigned a “fail” status.

Analysis of the second position may also include measuring a dropping of the hands of the subject by determining a distance corresponding to a decrease in hand height between the initial stance and the trigger. A “fail” status may be assigned based upon a decrease, for example, of approximately two or more inches. A “pass” status may be assigned when the decrease is, for example, less than approximately two inches.

Analysis of the second position may also include determining a straightness of the front arm by calculating an angle of the front arm, by measuring from the middle of a shoulder, through an elbow, to a wrist. A “pass” status may be assigned based upon a measurement of a minimum of approximately 10 or more degrees in the elbow angle at the trigger position as compared to the elbow angle at the initial stance. A “fail” status may be assigned when the arm has not opened up by at least approximately 10 degrees, or when the arm has straightened to within approximately 20 degrees of totally straight.

Analysis performed at a third position may include determining a distance that a front foot is lifted during a stride movement, by comparing a height of the bottom of the front foot at the point where their foot is the highest during stride to the bottom of the front foot in the stance position. A “fail” status may be assigned when the front foot is lifted more a predetermined distance, for example approximately six inches. A “fail” status may also be assigned when the front foot is lifted less than a predetermined distance, for example approximately one-half inch.

Analysis may be performed in a fourth position to determine, for example, a distance of a stride of a front foot. The distance of a stride of a front foot may depend on an age of the subject. Therefore, in assigning “pass” and “fail” statuses to the distance, subject age brackets may be utilized. For example, three age brackets may be defined, corresponding to 12 years and under, 13 to 15 years, and 16 years or older, respectively. A “fail” status may be assigned to a movement by a subject in the 12 years or under bracket when the stride is less than approximately 2.5 inches or more than approximately 6.5 inches. A “fail” status may be assigned to a movement by a subject in the 13 to 15 years bracket when the stride is less than approximately 2.5 inches or more than approximately 7.5 inches. A “fail” status may be assigned to a movement by a subject in the 16 years or older bracket when the stride is less than approximately 3.5 inches or more than approximately 9.5 inches.

Analysis performed at a fifth position may include a determination of whether the subject's hands are coming forward and down at approximately 45 degrees at the start of the swing movement. An angle of the hands as they move forward from the trigger position to the stroke position may be measured by comparing a position of a meeting of the hands on the bat at the trigger to a position of a meeting of the hands at a midpoint of the swing. A “pass” status may be assigned when the angle is between approximately 35 and 55 degrees, while a “fail” status may be assigned when the hands move forward and down less than approximately 35 degrees or more than approximately 55 degrees.

Additionally, analysis at the fifth position may include determining an angle of the bat at a midpoint of the swing by measuring the angle of the bat from tip to handle, relative to horizontal. A “pass” status may be assigned when the angle of the bat is between approximately zero degrees and 20 degrees from horizontal. A “fail” status may be assigned when a tip of the bat is lower than a handle of the bat or the tip is higher than the handle by approximately 12 inches.

The analyses described above are merely illustrative, and many other measurements may be performed using the calculated data and the answers to the questions provided by the user. Furthermore, the values and measurements discussed above with respect to determination of “pass” and “fail” statuses are likewise merely illustrative and are not meant to limit in any way the movements, measurement, or ranges of values that may be used in the respective determinations.

Audio and visual explanation corresponding to the determination then are associated with this particular movement. For instance, if the training wizard determines that the player did well, laudatory remarks may be associated with this particular movement. Similarly, for improvements and suggestions, corresponding audio and textual remarks are mapped according to the player's movement. In one embodiment, the data stored in the knowledge bank are also in an XML format. The data stored in the knowledge bank are thus used as a reference data for comparison in creating a personal lesson. The data may pertain to general standards for proper motions, or alternatively may include specific data pertaining to professional players.

At 412, the training wizard generates an analysis based on the comparison of the player's data and the knowledge bank data. Proper and improper position determinations, and recommendations and suggestions for improvements, thus in one embodiment are based on whether the player's data fall within a predetermined variance of the data stored in the knowledge bank. This analysis is used during the interactive lesson, for instance, while showing the user's swing positions either alone or in a side-by-side sync positions with that of a professional player. The x-y coordinates of the various parts are also used as position coordinates for determining the location of telestrations.

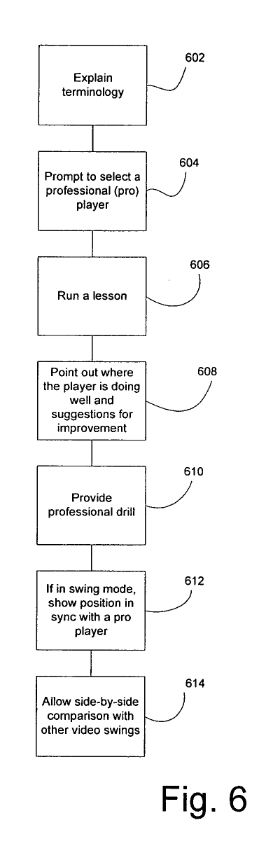

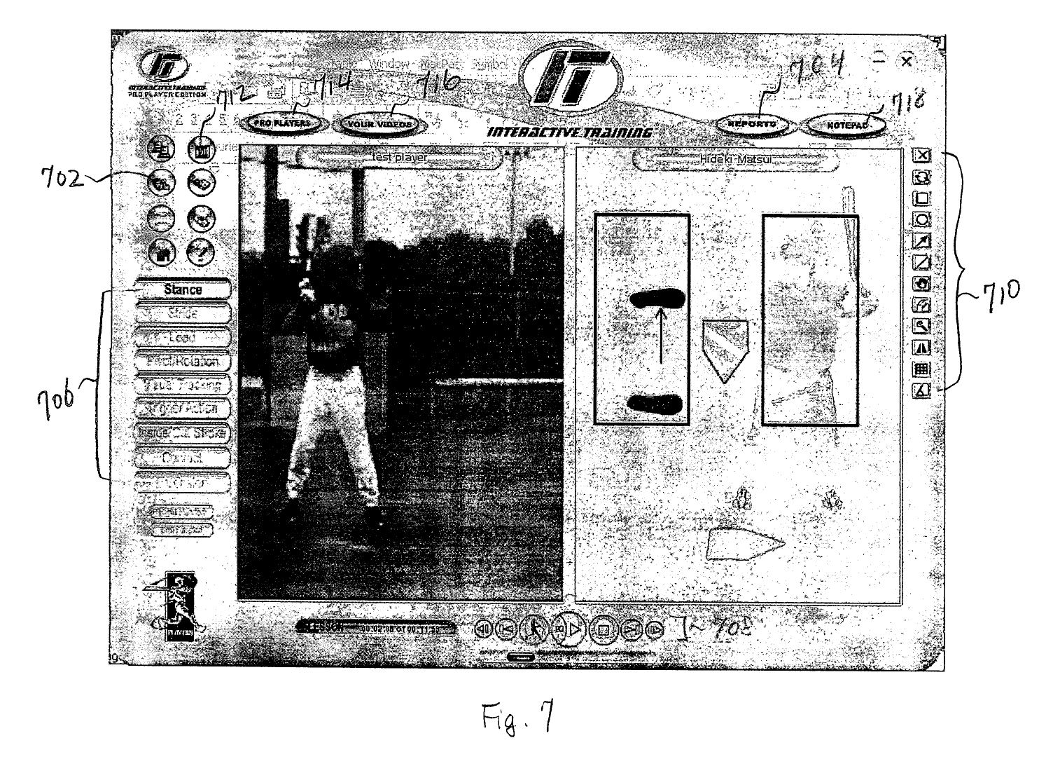

FIG. 6 is a flow diagram illustrating the method for providing an interactive lesson in one embodiment. The interactive lesson component in one embodiment, at the start of the lesson explains the different terminologies used in the sport of the lesson being provided, for instance, including the terminologies for different positions. The explanation, in one embodiment, is further accompanied with a pro player demonstrating the position or the move associated with the particular terminology being explained. Moreover, the explanation can be repeated at any time by pressing a button on a screen. At 604, the user is presented with a list of pro players with whom the user would like to have the lesson, for instance. At any time during the lesson, the user may switch to a different pro player, for instance, by pressing a button on a screen (for example, FIG. 7, 714). At 606, an automatic lesson begins with a side-by-side picture of the selected pro player as shown in FIG. 7.

A lesson, for example, includes pre-recorded demonstrations of body forms, for instance, for stance, stride, load, pivot and rotation, visual tracking, trigger action of hands, stroke, contact, and extension and follow through. An automatic lesson, using the analyzed positions of the player at the plate, as described above with reference to the training wizard, points out where the player is doing well and where he or she needs improvements at 608.

At 610, professional drills, which use professional players in each of the different body forms, can also be viewed using control buttons on the screen. The professional drills, for example, are pre-recorded videos that contain a professional player demonstrating each of the selected moves. The professional player, for instance, explains the basic techniques, including proper body position, weight distribution, the extent to which certain muscles should be tensioned or flexed, where a player should be looking, and the general “feel” of a good swing. Anytime during the lesson, a user can pause, use telestrations to analyze and compare his or her swing with the professional player of choice in all key frame positions, for instance, in a side-by-side relationship.

Additionally, in an embodiment of the present application, information associated with the drills may be stored in a file in XML format. An example of a file in XML format that stores information associated with the drills is provided in the appendix attached hereto and entitled “Rule.xml”.

The interactive lesson component in one embodiment comprises a lesson mode and a swing mode. Referring to FIG. 7, a user may toggle between these two modes at any time by clicking a mode toggle button 702 in one embodiment. Lesson mode allows the user to navigate through a fully automated, telestrated, and audio/visual overview of proper swing mechanics. The lesson also provides the user with detailed feedback on where the player is doing well in his or her own swing as demonstrated in the swing video, and where the system and method determines that there is a need for some improvement. These are summarized as reports, for instance, in the right hand frame.

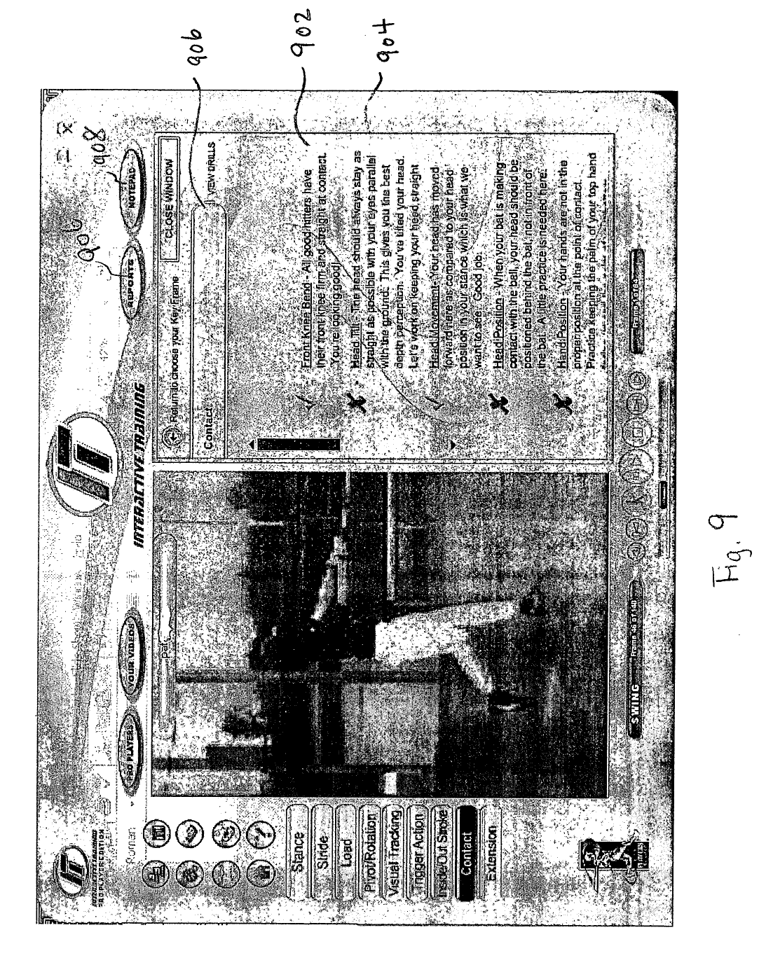

FIG. 9 is a screen shot that illustrates an example report. For instance, clicking on the “Reports” button 906 and selecting a key position display a detailed personal analysis report. The analysis, as described above, was generated using the various body movements and positions calculated from the body parts clicked on by the user as well as the answers to the questions during the training wizard session. The analysis points out what the player is doing well 902 as well as suggesting improvements 904. These summaries may also be printed and brought to a coach or to the field for specific practice. An example of a printed analysis report according to an embodiment of the present application is provided in the appendix attached hereto and entitled “Hitting Analysis Report”.

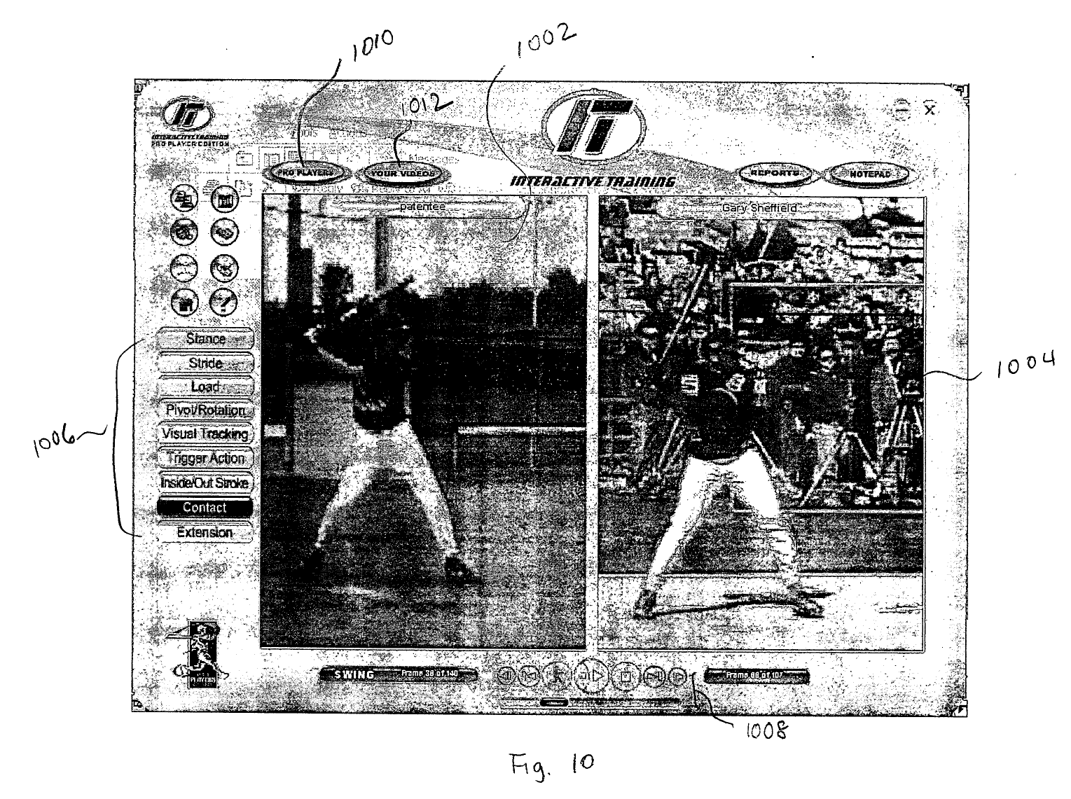

At 612, swing mode allows a user to review, analyze, and compare his or her swing to the big league stars or the professionals. Swing mode automatically synchronizes the player's swing from stance to follow-through with any pro player the user chooses, regardless of style or speed. FIG. 10 is a screen shot that shows an example of side-by-side synchronized positions of the player (for whom the lesson is created) 1002 and a professional player 1004 in the swing mode. The key positions are also synchronized, allowing the user to review and compare himself or herself in each of the key positions simply by clicking on the position buttons 1006, for instance, shown along the left hand side of the video frame. These key positions are illustrated for examples only, and therefore, are not limited to the list shown. Thus, other positions may be contemplated as necessary or desired. A user can use the control buttons and a slider bar 1008 at the bottom of the screen to review his or her swing using play, frame-by-frame advance, and frame-by-frame rewind.

While clicking on the “pro player” button 1010 synchronizes the video swing and the key positions of the player 1002 with those of a profession player as described above, clicking on the “your videos” 1012 button allows a synchronized side-by-side view of any other captured video swings. These may include previous video swings of the same player captured, for example, a week or month ago before the lesson started. This way, the player's progress in batting can be measured or viewed. In addition, the side-by-side video swing can be that of any other person with whom the player would like to compare his or her swing. Thus, for example, when the user clicks on the “your video” button 1012, the system and method of the present application in one embodiment lists the captured video swings for the user to select, then displays the selected video swing in a side-by-side manner with the current video swing.

In one embodiment, the swing videos are synchronized at each key position in the swing videos. The system and method of the present application computes the number of still frames, for example, from a key position to the next key position and presents those still frames in a predetermined speed such that the two side-by-side presentations of the swings synchronize at the next key position. For instance, if a player video swing includes 8 still frames from the stance position to the stride position and a professional player video swing includes 10 still frames in the same position interval, the player's 8 still frames are presented at a slower pace than the professional player's 10 still frames so that at the stride position, the still frames of the player and the professional match up and thus synchronized.

Referring back to FIG. 7, a telestration toolbar 710 is provided which allows a user to draw his or her own lines, arrows, circles, and boxes on either player. There is also an angle measurement tool, which is useful for comparing the body positions between the pro player of choice, and the player's own position. In one embodiment, clicking the “Tools” button 712 in the top left circular panel opens the manual telestration toolbar 710. The tool bar is “floating”, which means it can be dragged anywhere on the screen. The tool bar also allows the user to turn on and off the grid feature, which is useful for tracking the movement of the player's positions as the user controls the swing videos. Another useful feature is the zoom function. To use the zoom feature, a user may click on the magnifying glass symbol on the toolbar, and then click on + or − buttons directly below the player to zoom. By clicking an email button, a user can email the swing video to a recipient of user's choice. The “notepad” button 718 allows the user to create his or her personal notes that can be stored and read at any time.

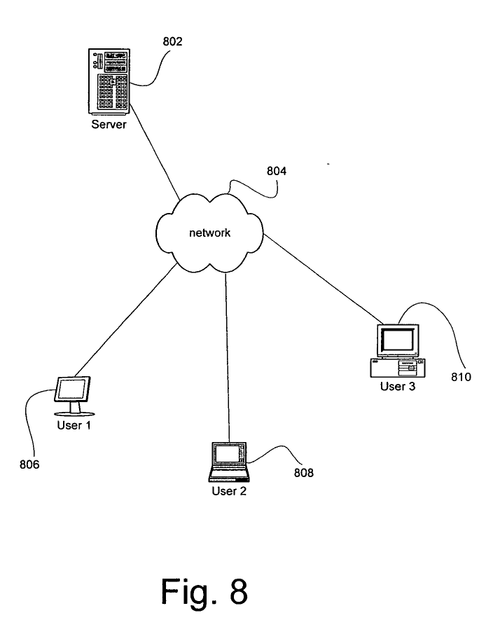

The system and method of present application may be embodied as a software program that runs on a processor, for example, a personal computer. FIG. 8 is a network diagram that illustrates an example topology for the system and method disclosed. The program can be downloaded from a website of a server 802, for instance, via a network 804 such as the Internet to the individual user's systems 806, 808, 810. A user 806, also may upload a captured video swing to the server 802, then have another user 804 download the captured video swing that was uploaded, so that, for instance, the second user 804 can create an interactive lesson from the video swing. For example, a coach may capture the video swings of his team members and upload the video swings to the server. The individual members of the team then may download their own respective swings to their computers and create a personalized lesson of their own. In addition, one user may upload a video swing to the server, so that another user can retrieve the video swing for viewing. For instance, for their enjoyment, a grandparent can download their grandchild's video swing that was uploaded previously.

In another embodiment, the system and method of the present application allows the user to perform a follow up analysis that compares his or her previous swing videos to the later ones, for instance, to measure the progress or improvements that he or she has made over time through the lessons. Thus, at 614, the user may compare the video swings, for instance, by allowing the side-by-side views of the player's current video swing with that of his or her previous video swings. To view the side-by-side comparison, the user may switch to a swing mode, then load another video swing, for instance, by pressing “your video” button as explained above. The side-by-side videos of the swing then can be viewed fully synched with one another in slow motion, normal play speed, or on a frame-by-frame basis. The user may load the video swings that were saved in the remote server or his or her local computer.

The video capture wizard, the training wizard, and the interactive lesson components can either be run separately at different times, or run all at one sitting. Thus, a user may first capture a video swing, come back later and run the training wizard. Similarly, the interactive lesson may be run at any time after the training wizard is run at least once to create a personalized lesson. Thereafter, a user may run the interactive lesson as many times and as often as he or she desires.

The system and method of the present disclosure may be implemented and run on a general-purpose computer. The embodiments described above are illustrative examples and it should not be construed that the present invention is limited to these particular embodiments. Thus, various changes and modifications may be effected by one skilled in the art without departing from the spirit or scope of the invention as defined in the appended claims.

### APPENDIX

### Hitting Analysis Report

Hitting Analysis Report

Stance

1 Feet Width—We need to work on your foot position when you are at stance. Having your feet positioned too far apart may cause you to drop your back shoulder and you'll have a tendency to hit a lot of fly balls or swing and miss underneath the pitch. If your feet are too close together at stance, you have a tendency to stride too long.
2 Hand Height—Consider trying to hold your hands a little lower in your stance and see if you have more success at the plate.
3 Knee Alignment—We need to work on the position of your knees. Your knees should be lined up with the insides of your feet. Your knees should never get outside the feet in your stance, stride or swing.
4 Shoulder Height—Your shoulders are the same height. Good work.
5 Feet Direction—Your feet are pointing straight at home plate. Keep up the good work.
6 Foot Distance—Excellent job. Your feet are the same distance from home plate in the square stance. This gives you the best opportunity to hit outside and inside pitches.
7 Weight Distribution—You have a slight flex in your knees and are distributing your weight equally on both legs. You're looking like a Pro!
8 Knee Flex—This is an area we need to improve. Flexing your back knee too much causes you to open up in the front shoulder too early in your swing.
9 Parallel Shoulders—Your shoulders are parallel with home plate. This is the shoulder position we're looking for. Keep up the good work.
10 Hand Depth—Your hands are positioned at a good depth in relation to your body. Keep it up.
11 Distance of Hands—Excellent job. This is a key point and you're in the proper position.
12 Arm Positions—Your arms are in a good position here. The coach gives you a tip of the hat.
13 Elbow Positions—You're looking good here. You have your elbows in the proper position.
14 Eye Level—Perfect. Keeping your eyes parallel to the ground is the best way to visually track the ball to the plate.
15 Bat Angle—You're looking like the Pro here. Way to go.
   Stride
1 Stride Height—Good job. You're striding with the low glide step we want to see here.
2 Stride Length—We need to spend some practice time on your stride length. If you stride too long the weight of your body goes forward before it should.
3 Stride Direction—Excellent. You're striding straight ahead which gives you the best chance in hitting both inside and outside pitches.
   Load
1 Back Knee Flex—You must load up or shift your body weight back towards the catcher. A slight flex in your back knee here is a load technique that will transfer more body weight to your back leg. Good work.
2 Front Knee Position—Good job. Your knee is positioned behind or back from your front foot.
   Pivot
1 Pivot Height—You're looking more like a Pro every day. You have a nice high finish with your back heel on your pivot.
2 Pivot Finish—Great job. You've finished your pivot with your back heel pointing straight back.
3 Front Knee Collapse—You've collapsed your front knee so it's now in front of your front foot. Many young hitters do this so you're not alone. Your front knee should never be in front of your front foot during your swing. Work on keeping that front leg tall and firm.
4 Front Foot—Your front foot has opened up to about a 45 degree angle to the front edge of home plate. Keep up the good work.
   Trigger
1 Elbow Action—You're letting your back elbow fly up too high during your trigger. This is a very common mistake. Work on keeping that back elbow even with or slightly higher than your front elbow at this point of your swing.
2 Movement of Hands—You're not triggering your hands back the proper amount. For the greatest hitting success try triggering your hands back 2-3 inches from your hand position at stance.
3 Hitching Hands—You triggered your hands basically straight back from your hand position at stance. Solid fundamentals like this will pay you big dividends at the plate.
4 Front Arm Position—Let's spend some practice time on your front arm position at the completion of your trigger. We want to see your arm straighter than it was during your stance, but not so straight that you have a stiff front arm.
5 Trigger with the shoulders and not with the Hands—You want to trigger with your hands. If you turn your front shoulder in too much toward the plate you will be triggering with the shoulders and not with the hands. If you trigger with your shoulders then you will swing with your shoulders, and you cannot take the bat to the different zones. Spend some practice time correcting this.
6 Rear Elbow Extention—You've triggered around the back side of your body with your hands so far that your back elbow is pointing in the direction of the dugout behind you. This adds length to your swing so your swing will not be short, straight and compact to the ball. Practice triggering straight back with your hands, keeping them visible to the pitcher.
7 Bat Position—Great job. Next time we'll have to use you as our example instead of the Pro Player.
   Stroke
1 Angle of your Hands—You're not bringing your hands down at about a 45 degree angle to the ground as your bat approaches the ball. Work on bringing your hands down smoothly as you swing.
2 Bat Angle—At the half way point in your swing your bat is parallel to the ground or slightly elevated like you want it to be. You're looking good here.
   Contact
1 Back Arm Position—Good job. At the point of contact, your back arm should still be bent which helps you drive through the ball.
2 Front Arm Position—At the point of contact your front arm should be basically extended. Good work.
3 Hand Position—The palms of your hands are in the proper position here. Keep up the good work and you may just become the best hitter on your team.
4 Head Position—The bat should be in front of your head when the bat hits the ball. You're in good position here.
5 Head Movement—Your head has moved forward here as compared to your head position in your stance which is what we want to see. Good job.
6 Head Tilt—The head should always stay as straight as possible with your eyes parallel with the ground. This gives you the best depth perception. You've tilted your head. Let's work on keeping your head straight.
7 Front Knee Bend—All good hitters have their front knee firm and straight at contact. You're looking good!
   Extension
1 Front Arm Extension—Good front arm extension allows you to hit the ball further. You're doing great here. Keep up your good front arm extension and you'll be hitting it over the fence.
2 Plane of the Bat—You're smooth. Keeping your bat on the same plane before, during and after your swing helps your bat make more solid contact with the baseball. Great job.
3 Chin Position—Way to go! You're in a good position here keeping your chin down on your back shoulder.
4 Front Foot Rollover—Effective hitters do not rollover on the outside of their front foot. Devote some practice time to keeping that front foot flat and solid on the ground when you follow through.

### KFEWizardOutput.xml

```
- <KFEWizardOutput>
  - <Stance distance=“ ” rotation=“ ” frame=“23”>
    - <QuestionCollection count=“11”>
        <Question correct=“ ” answer=“A” literal=“1” />
        <Question correct=“ ” answer=“A” literal=“2” />
        <Question correct=“ ” answer=“A” literal=“3” />
        <Question correct=“ ” answer=“A” literal=“4” />
        <Question correct=“ ” answer=“A” literal=“5” />
        <Question correct=“ ” answer=“A” literal=“6” />
        <Question correct=“ ” answer=“A” literal=“7” />
        <Question correct=“ ” answer=“A” literal=“8” />
        <Question correct=“ ” answer=“A” literal=“9” />
        <Question correct=“ ” answer=“A” literal=“10” />
        <Question correct=“ ” answer=“A” literal=“11” />
      </QuestionCollection>
    - <PointCollection count=“10”>
        <Point name=“FFI” y=“457.95” x=“167.5” />
        <Point name=“BFI” y=“455.95” x=“69.65” />
        <Point name=“FSM” y=“186” x=“142.1” />
        <Point name=“BSM” y=“186” x=“87.55” />
        <Point name=“FLK” y=“363.95” x=“146.8” />
        <Point name=“BLK” y=“361.95” x=“76.25” />
        <Point name=“ET” y=“155” x=“111.05” />
        <Point name=“BHT” y=“144” x=“84.7” />
        <Point name=“HMB” y=“153” x=“77.2” />
        <Point name=“FE” y=“209” x=“107.3” />
      </PointCollection>
    - <DataCollection count=“1”>
        <Data value=“12” text=“Back Leg Length (inches)”
        name=“LEG” />
      </DataCollection>
    </Stance>
  - <Stride distance=“ ” rotation=“ ” frame=“45”>
    - <QuestionCollection count=“1”>
        <Question correct=“ ” answer=“A” literal=“1” />
      </QuestionCollection>
    - <PointCollection count=“2”>
        <Point name=“FFBSS” y=“453.95” x=“221.15” />
        <Point name=“FFHIE” y=“469.95” x=“256.9” />
      </PointCollection>
    - <DataCollection count=“1”>
        <Data value=“8” text=“User Age” name=“AGE” />
      </DataCollection>
    </Stride>
  - <Load distance=“ ” rotation=“ ” frame=“39”>
    - <QuestionCollection count=“2”>
        <Question correct=“ ” answer=“A” literal=“1” />
        <Question correct=“ ” answer=“A” literal=“2” />
      </QuestionCollection>
    </Load>
  - <Pivot distance=“ ” rotation=“ ” frame=“54”>
    - <QuestionCollection count=“4”>
        <Question correct=“ ” answer=“A” literal=“1” />
        <Question correct=“ ” answer=“A” literal=“2” />
        <Question correct=“ ” answer=“A” literal=“3” />
        <Question correct=“ ” answer=“A” literal=“4” />
      </QuestionCollection>
    </Pivot>
    <Visual distance=“ ” rotation=“ ” frame=“52” />
  - <Trigger distance=“ ” rotation=“ ” frame=“39”>
    - <QuestionCollection count=“3”>
        <Question correct=“ ” answer=“A” literal=“1” />
        <Question correct=“ ” answer=“A” literal=“2” />
        <Question correct=“ ” answer=“A” literal=“3” />
      </QuestionCollection>
    - <PointCollection count=“7”>
        <Point name=“HMB” y=“249” x=“31.05” />
        <Point name=“BET” y=“238” x=“56.45” />
        <Point name=“FE” y=“263” x=“94.1” />
        <Point name=“FSM” y=“214” x=“130.8” />
        <Point name=“BFT” y=“457.95” x=“64.95” />
        <Point name=“FFT” y=“451.95” x=“215.5” />
        <Point name=“DUMMY” y=“365.95” x=“160.95” />
      </PointCollection>
    </Trigger>
  - <Stroke distance=“ ” rotation=“ ” frame=“52”>
    - <PointCollection count=“3”>
        <Point name=“HMB” y=“206” x=“207.05” />
        <Point name=“BT” y=“182” x=“96” />
        <Point name=“BHE” y=“211” x=“226.8” />
      </PointCollection>
    </Stroke>
  - <Contact distance=“ ” rotation=“ ” frame=“54”>
    - <QuestionCollection count=“7”>
        <Question correct=“ ” answer=“A” literal=“1” />
        <Question correct=“ ” answer=“A” literal=“2” />
        <Question correct=“ ” answer=“A” literal=“3” />
        <Question correct=“ ” answer=“A” literal=“4” />
        <Question correct=“ ” answer=“A” literal=“5” />
        <Question correct=“ ” answer=“A” literal=“6” />
        <Question correct=“ ” answer=“A” literal=“7” />
      </QuestionCollection>
    - <PointCollection count=“5”>
        <Point name=“BT” y=“256” x=“290.8” />
        <Point name=“BK” y=“226” x=“172.2” />
        <Point name=“MHC” y=“219” x=“283.25” />
        <Point name=“BAC” y=“240” x=“220.2” />
        <Point name=“BFC” y=“431.95” x=“92.25” />
      </PointCollection>
    </Contact>
  - <Extension distance=“ ” rotation=“ ” frame=“55”>
    - <QuestionCollection count=“4”>
        <Question correct=“ ” answer=“A” literal=“1” />
        <Question correct=“ ” answer=“A” literal=“2” />
        <Question correct=“ ” answer=“A” literal=“3” />
        <Question correct=“ ” answer=“A” literal=“4” />
      </QuestionCollection>
    - <PointCollection count=“4”>
        <Point name=“BTE” y=“209” x=“240.9” />
        <Point name=“FAE” y=“209” x=“240.9” />
        <Point name=“TE” y=“332.95” x=“221.15” />
        <Point name=“BFE” y=“400.65” x=“753.05” />
      </PointCollection>
    </Extension>
  </KFEWizardOutput>
```

### Rule.xml

```
  <?xml version=“1.0” encoding=“utf-8” ?>
- <KeyFrameCollection count=“8”>
  - <KeyFrame name=“STANCE”>
    - <RuleCollection count=“4”>
      - <Rule name=“FeetWidth” validFile=“Stance.FeetWidth.Pass.txt”
          validSound=“Feet Width Pass.swf”
          invalidFile=“Stance.FeetWidth.Fail.txt” invalidSound=“Feet Width
          Fail.swf”>
        - <DrillCollection count=“2”>
            <Drill name=“FeetWidthDrill1” file=“FeetWidthDrill1.swf” />
            <Drill name=“FeetWidthDrill2” file=“FeetWidthDrill2.swf” />
          </DrillCollection>
        </Rule>
      - <Rule name=“HandHeight” validFile=“Stance.HandHeight.Pass.txt”
          validSound=“Hand Height Pass.swf”
          invalidFile=“Stance.HandHeight.Fail.TooHigh.txt” invalidSound=“Hand
          Height Fail High.swf”
          invalidFile2=“Stance.HandHeight.Fail.TooLow.txt”
          invalidSound2=“Hand Height Fail Low.swf”>
        - <DrillCollection count=“2”>
            <Drill name=“HandHeightDrill1” file=“HandHeightDrill1.swf” />
            <Drill name=“HandHeightDrill2” file=“HandHeightDrill2.swf” />
          </DrillCollection>
        </Rule>
      - <Rule name=“KneeAlignment”
          validFile=“Stance.KneeAlignment.Pass.txt” validSound=“Knee Align
          Pass.swf” invalidFile=“Stance.KneeAlignment.Fail.txt”
          invalidSound=“Knee Align Fail.swf”>
        - <DrillCollection count=“2”>
            <Drill name=“KneeAlignmentDrill1”
              file=“KneeAlignmentDrill1.swf” />
            <Drill name=“KneeAlignmentDrill2”
              file=“KneeAlignmentDrill2.swf” />
          </DrillCollection>
        </Rule>
      - <Rule name=“ShoulderHeight”
          validFile=“Stance.ShoulderHeight.Pass.txt” validSound=“Shoulder
          Height Pass.swf” invalidFile=“Stance.ShoulderHeight.Fail.txt”
          invalidSound=“Shoulder Height Fail.swf”>
        - <DrillCollection count=“2”>
            <Drill name=“ShoulderHeightDrill1”
              file=“ShoulderHeightDrill1.swf” />
            <Drill name=“ShoulderHeightDrill2”
              file=“ShoulderHeightDrill2.swf” />
          </DrillCollection>
        </Rule>
      </RuleCollection>
    </KeyFrame>
  - <KeyFrame name=“STRIDE”>
    - <RuleCollection count=“2”>
      - <Rule name=“FootHeight” validFile=“Stride.StrideHeight.Pass.txt”
          validSound=“Stride Height Pass.swf”
          invalidFile=“Stride.StrideHeight.Fail.txt” invalidSound=“Stride Height
      Fail.swf”>
        - <DrillCollection count=“2”>
            <Drill name=“FootHeightDrill1” file=“FootHeightDrill1.swf” />
            <Drill name=“FootHeightDrill2” file=“FootHeightDrill2.swf” />
          </DrillCollection>
        </Rule>
      - <Rule name=“FootMovement” validFile=“Stride.StrideLength.Pass.txt”
          validSound=“Stride Length Pass.swf”
          invalidFile=“Stride.StrideLength.Fail.txt” invalidSound=“Stride Length
          Fail.swf”>
        - <DrillCollection count=“2”>
            <Drill name=“FootMovementDrill1”
              file=“FootMovementDrill1.swf” />
            <Drill name=“FootMovementDrill2”
              file=“FootMovementDrill2.swf” />
          </DrillCollection>
        </Rule>
      </RuleCollection>
    </KeyFrame>
  - <KeyFrame name=“TRIGGER”>
    - <RuleCollection count=“4”>
      - <Rule name=“ElbowHeight” validFile=“TriggerAction.Elbow.Pass.txt”
          validSound=“Elbow Pass.swf”
          invalidFile=“TriggerAction.Elbow.Fail.txt” invalidSound=“Elbow
          Fail.swf”>
        - <DrillCollection count=“2”>
            <Drill name=“ElbowHeightDrill1”
              file=“ElbowHeightDrill1.swf” />
            <Drill name=“ElbowHeightDrill2”
              file=“ElbowHeightDrill2.swf” />
          </DrillCollection>
        </Rule>
      - <Rule name=“HorizontalHandMovement”
          validFile=“TriggerAction.Hands.Pass.txt” validSound=“Hands
          Pass.swf” invalidFile=“TriggerAction.Hands.Fail.txt”
          invalidSound=“Hands Fail.swf”>
        - <DrillCollection count=“2”>
            <Drill name=“HorizontalHandMovementDrill1”
              file=“HorizontalHandMovementDrill1.swf” />
            <Drill name=“HorizontalHandMovementDrill2”
              file=“HorizontalHandMovementDrill2.swf” />
          </DrillCollection>
        </Rule>
      - <Rule name=“VerticalHandMovement”
          validFile=“TriggerAction.HitchingHands.Pass.txt” validSound=“Hitch
          Hands Pass.swf” invalidFile=“TriggerAction.HitchingHands.Fail.txt”
          invalidSound=“Hitch Hands Fail.swf”>
        - <DrillCollection count=“2”>
            <Drill name=“VerticalHandMovementDrill1”
              file=“VerticalHandMovementDrill1.swf” />
            <Drill name=“VerticalHandMovementDrill2”
              file=“VerticalHandMovementDrill2.swf” />
          </DrillCollection>
        </Rule>
      - <Rule name=“ArmAngle”
          validFile=“TriggerAction.FrontArmPosition.Pass.txt” validSound=“Frt
          Arm Pos Pass.swf”
          invalidFile=“TriggerAction.FrontArmPosition.Fail.txt”
          invalidSound=“Frt Arm Pos Fail.swf”>
        - <DrillCollection count=“2”>
            <Drill name=“ArmAngleDrill1” file=“ArmAngleDrill1.swf” />
            <Drill name=“ArmAngleDrill2” file=“ArmAngleDrill2.swf” />
          </DrillCollection>
        </Rule>
      </RuleCollection>
    </KeyFrame>
  - <KeyFrame name=“STROKE”>
    - <RuleCollection count=“2”>
      - <Rule name=“HandAngle” validFile=“Stroke.HandAngle.Pass.txt”
          validSound=“Angle of the Hands Pass.swf”
          invalidFile=“Stroke.HandAngle.Fail.txt” invalidSound=“Angle of the
          Hands Fail.swf”>
        - <DrillCollection count=“2”>
            <Drill name=“HandAngleDrill1” file=“HandAngleDrill1.swf” />
            <Drill name=“HandAngleDrill2” file=“HandAngleDrill2.swf” />
          </DrillCollection>
        </Rule>
      - <Rule name=“BatAngle” validFile=“Stroke.BatAngle.Pass.txt”
          validSound=“Bat Angle Pass.swf”
          invalidFile=“Stroke.BatAngle.Fail.txt” invalidSound=“Bat Angle
          Fail.swf”>
        - <DrillCollection count=“2”>
            <Drill name=“BatAngleDrill1” file=“BatAngleDrill1.swf” />
            <Drill name=“BatAngleDrill2” file=“BatAngleDrill2.swf” />
          </DrillCollection>
        </Rule>
      </RuleCollection>
    </KeyFrame>
  </KeyFrameCollection>
```

### Summary Output.xml

```
- <SummaryOutput>
  - <Stance count=“15”>
    - <Item name=“Item1” text=“Stance.FeetWidth.Fail.txt” sound=“Feet Width
        Fail.swf” valid=“False”>
      - <DrillCollection count=“2”>
          <Drill name=“FeetWidthDrill1” file=“FeetWidthDrill1.swf” />
          <Drill name=“FeetWidthDrill2” file=“FeetWidthDrill2.swf” />
        </DrillCollection>
      </Item>
    - <Item name=“Item2” text=“Stance.HandHeight.Fail.TooHigh.txt”
        sound=“Hand Height Fail High.swf” valid=“False”>
      - <DrillCollection count=“2”>
          <Drill name=“HandHeightDrill1” file=“HandHeightDrill1.swf” />
          <Drill name=“HandHeightDrill2” file=“HandHeightDrill2.swf” />
        </DrillCollection>
      </Item>
    - <Item name=“Item3” text=“Stance.KneeAlignment.Fail.txt” sound=“Knee
        Align Fail.swf” valid=“False”>
      - <DrillCollection count=“2”>
          <Drill name=“KneeAlignmentDrill1”
            file=“KneeAlignmentDrill1.swf” />
          <Drill name=“KneeAlignmentDrill2”
            file=“KneeAlignmentDrill2.swf” />
        </DrillCollection>
      </Item>
    - <Item name=“Item4” text=“Stance.ShoulderHeight.Pass.txt”
        sound=“Shoulder Height Pass.swf” valid=“True”>
        <DrillCollection count=“0” />
      </Item>
    - <Item name=“Item5” text=“Stance.FeetDirection.Yes.txt” sound=“Feet Dir
        Yes.swf” valid=“True”>
        <DrillCollection count=“0” />
      </Item>
    - <Item name=“Item6” text=“Stance.FootDistance.Yes.txt” sound=“Foot
        Distance Yes.swf” valid=“True”>
        <DrillCollection count=“0” />
      </Item>
    - <Item name=“Item7” text=“Stance.KneeFlex.Yes.txt” sound=“Knee Flex
        Yes.swf” valid=“True”>
        <DrillCollection count=“0” />
      </Item>
    - <Item name=“Item8” text=“Stance.UnequalKneeFlexion.Yes.txt”
        sound=“Unequal Knee Flex Yes.swf” valid=“False”>
      - <DrillCollection count=“2”>
          <Drill name=“StanceQ4Drill1” file=“StanceQ4Drill1.swf” />
          <Drill name=“StanceQ4Drill2” file=“StanceQ4Drill2.swf” />
        </DrillCollection>
      </Item>
    - <Item name=“Item9” text=“Stance.ParallelShoulders.Yes.txt”
        sound=“Parallel Shoulders Yes.swf” valid=“True”>
        <DrillCollection count=“0” />
      </Item>
    - <Item name=“Item10” text=“Stance.HandDepth.Yes.txt” sound=“Hand
    Depth Yes.swf” valid=“True”>
        <DrillCollection count=“0” />
      </Item>
    - <Item name=“Item11” text=“Stance.HandDistance.Yes.txt” sound=“Dist of
        Hands Yes.swf” valid=“True”>
        <DrillCollection count=“0” />
      </Item>
    - <Item name=“Item12” text=“Stance.ArmPosition.Yes.txt” sound=“Arm Pos
        Yes.swf” valid=“True”>
        <DrillCollection count=“0” />
      </Item>
    - <Item name=“Item13” text=“Stance.ElbowPosition.Yes.txt” sound=“Elbow
        Pos Yes.swf” valid=“True”>
        <DrillCollection count=“0” />
      </Item>
    - <Item name=“Item14” text=“Stance.HeadEyes.Yes.txt” sound=“HeadEyes
        Yes.swf” valid=“True”>
        <DrillCollection count=“0” />
      </Item>
    - <Item name=“Item15” text=“Stance.BatAngle.Yes.txt” sound=“Bat Angle
        Yes.swf” valid=“True”>
        <DrillCollection count=“0” />
      </Item>
    </Stance>
  - <Stride count=“3”>
    - <Item name=“Item1” text=“Stride.StrideHeight.Pass.txt” sound=“Stride
        Height Pass.swf” valid=“True”>
        <DrillCollection count=“0” />
      </Item>
    - <Item name=“Item2” text=“Stride.StrideLength.Fail.txt” sound=“Stride
        Length Fail.swf” valid=“False”>
      - <DrillCollection count=“2”>
          <Drill name=“FootMovementDrill1”
            file=“FootMovementDrill1.swf” />
          <Drill name=“FootMovementDrill2”
            file=“FootMovementDrill2.swf” />
        </DrillCollection>
      </Item>
    - <Item name=“Item3” text=“Stride.StrideDirection.Yes.txt” sound=“Stride
        Direction Yes.swf” valid=“True”>
        <DrillCollection count=“0” />
      </Item>
    </Stride>
  - <Load count=“2”>
    - <Item name=“Item1” text=“Load.BackKneeFlex.Yes.txt” sound=“Back
        Knee Flex Yes.swf” valid=“True”>
        <DrillCollection count=“0” />
      </Item>
    - <Item name=“Item2” text=“Load.FrontKneePosition.Yes.txt” sound=“Frt
        Knee Pos Yes.swf” valid=“False”>
      - <DrillCollection count=“2”>
          <Drill name=“LoadQ2Drill1” file=“LoadQ2Drill1.swf” />
          <Drill name=“LoadQ2Drill2” file=“LoadQ2Drill2.swf” />
        </DrillCollection>
      </Item>
    </Load>
  - <Pivot count=“4”>
    - <Item name=“Item1” text=“Pivot.PivotHeight.Yes.txt” sound=“Pivot Hgt
        Yes.swf” valid=“True”>
        <DrillCollection count=“0” />
      </Item>
    - <Item name=“Item2” text=“Pivot.PivotFinish.Yes.txt” sound=“Pivot Finish
        1.swf” valid=“True”>
        <DrillCollection count=“0” />
      </Item>
    - <Item name=“Item3” text=“Pivot.FrontKneeCollapse.Yes.txt” sound=“Frt
        Knee Collapse Yes.swf” valid=“False”>
      - <DrillCollection count=“2”>
          <Drill name=“PivotQ3Drill1” file=“PivotQ3Drill1.swf” />
          <Drill name=“PivotQ3Drill2” file=“PivotQ3Drill2.swf” />
        </DrillCollection>
      </Item>
    - <Item name=“Item4” text=“Pivot.FrontFoot.Yes.txt” sound=“Front Foot
        Yes.swf” valid=“True”>
        <DrillCollection count=“0” />
      </Item>
    </Pivot>
    <Visual count=“0” />
  - <Trigger count=“7”>
    - <Item name=“Item1” text=“TriggerAction.Elbow.Fail.txt” sound=“Elbow
        Fail.swf” valid=“False”>
      - <DrillCollection count=“2”>
          <Drill name=“ElbowHeightDrill1” file=“ElbowHeightDrill1.swf” />
          <Drill name=“ElbowHeightDrill2” file=“ElbowHeightDrill2.swf” />
        </DrillCollection>
      </Item>
    - <Item name=“Item2” text=“TriggerAction.Hands.Fail.txt” sound=“Hands
        Fail.swf” valid=“False”>
      - <DrillCollection count=“2”>
          <Drill name=“HorizontalHandMovementDrill1”
            file=“HorizontalHandMovementDrill1.swf” />
          <Drill name=“HorizontalHandMovementDrill2”
            file=“HorizontalHandMovementDrill2.swf” />
        </DrillCollection>
      </Item>
    - <Item name=“Item3” text=“TriggerAction.HitchingHands.Pass.txt”
        sound=“Hitch Hands Pass.swf” valid=“True”>
        <DrillCollection count=“0” />
      </Item>
    - <Item name=“Item4” text=“TriggerAction.FrontArmPosition.Fail.txt”
        sound=“Frt Arm Pos Fail.swf” valid=“False”>
      - <DrillCollection count=“2”>
          <Drill name=“ArmAngleDrill1” file=“ArmAngleDrill1.swf” />
          <Drill name=“ArmAngleDrill2” file=“ArmAngleDrill2.swf” />
        </DrillCollection>
      </Item>
    - <Item name=“Item5” text=“TriggerAction.Shoulder.Yes.txt” sound=“Trig w
        Should Yes.swf” valid=“False”>
      - <DrillCollection count=“2”>
          <Drill name=“TriggerQ1Drill1” file=“TriggerQ1Drill1.swf” />
          <Drill name=“TriggerQ1Drill2” file=“TriggerQ1Drill2.swf” />
        </DrillCollection>
      </Item>
    - <Item name=“Item6” text=“TriggerAction.RearElbowExtention.Yes.txt”
        sound=“Real Elb Ext Yes.swf” valid=“False”>
      - <DrillCollection count=“2”>
          <Drill name=“TriggerQ2Drill1” file=“TriggerQ2Drill1.swf” />
          <Drill name=“TriggerQ2Drill2” file=“TriggerQ2Drill2.swf” />
        </DrillCollection>
      </Item>
    - <Item name=“Item7” text=“TriggerAction.Bat.Yes.txt” sound=“Bat
        Yes.swf” valid=“True”>
        <DrillCollection count=“0” />
      </Item>
    </Trigger>
  - <Stroke count=“2”>
    - <Item name=“Item1” text=“Stroke.HandAngle.Fail.txt” sound=“Angle of
        the Hands Fail.swf” valid=“False”>
      - <DrillCollection count=“2”>
          <Drill name=“HandAngleDrill1” file=“HandAngleDrill1.swf” />
          <Drill name=“HandAngleDrill2” file=“HandAngleDrill2.swf” />
        </DrillCollection>
      </Item>
    - <Item name=“Item2” text=“Stroke.BatAngle.Pass.txt” sound=“Bat Angle
        Pass.swf” valid=“True”>
        <DrillCollection count=“0” />
      </Item>
    </Stroke>
  - <Contact count=“7”>
    - <Item name=“Item1” text=“Contact.BackArmPosition.Yes.txt”
        sound=“Back Arm Pos Yes.swf” valid=“True”>
        <DrillCollection count=“0” />
      </Item>
    - <Item name=“Item2” text=“Contact.FrontArmPosition.Yes.txt” sound=“Frt
        Arm Pos Yes.swf” valid=“True”>
        <DrillCollection count=“0” />
      </Item>
    - <Item name=“Item3” text=“Contact.HandPosition.Yes.txt” sound=“Hand
        Pos Yes.swf” valid=“True”>
        <DrillCollection count=“0” />
      </Item>
    - <Item name=“Item4” text=“Contact.Head.Yes.txt” sound=“Head Yes.swf”
        valid=“True”>
        <DrillCollection count=“0” />
      </Item>
    - <Item name=“Item5” text=“Contact.HeadMovement.Yes.txt” sound=“Head
        Move Yes.swf” valid=“True”>
        <DrillCollection count=“0” />
      </Item>
    - <Item name=“Item6” text=“Contact.HeadTilt.Yes.txt” sound=“Head Tilt
        Yes.swf” valid=“False”>
      - <DrillCollection count=“2”>
          <Drill name=“ContactQ7Drill1” file=“ContactQ7Drill1.swf” />
          <Drill name=“ContactQ7Drill2” file=“ContactQ7Drill2.swf” />
        </DrillCollection>
      </Item>
    - <Item name=“Item7” text=“Contact.FrontKneeBend.Yes.txt” sound=“Frt
        Knee Bend Yes.swf” valid=“True”>
        <DrillCollection count=“0” />
      </Item>
    </Contact>
  - <Extension count=“4”>
    - <Item name=“Item1” text=“Extension.FrontArm.Yes.txt” sound=“Frt Arm
        Ext Yes.swf” valid=“True”>
        <DrillCollection count=“0” />
      </Item>
    - <Item name=“Item2” text=“Extension.BatAngle.Yes.txt” sound=“Bat Angle
        Yes.swf” valid=“True”>
        <DrillCollection count=“0” />
      </Item>
    - <Item name=“Item3” text=“Extension.HeadChin.Yes.txt” sound=“Head
        Chin Yes.swf” valid=“True”>
        <DrillCollection count=“0” />
      </Item>
    - <Item name=“Item4” text=“Extension.FrontFootRollover.Yes.txt”
        sound=“Frt Foot Rollover Yes.swf” valid=“False”>
      - <DrillCollection count=“2”>
          <Drill name=“ExtensionQ4Drill1” file=“ExtensionQ4Drill1.swf” />
          <Drill name=“ExtensionQ4Drill2” file=“ExtensionQ4Drill2.swf” />
        </DrillCollection>
      </Item>
    </Extension>
  </SummaryOutput>
```

### TelestrationOutput.xml

```
- <TelestrationOutput>
  - <Stance frame=“23” rotation=“0” distance=“0”>
    - <PointCollection count=“10”>
        <Point name=“FFI” x=“168” y=“458” animation=“ ” />
        <Point name=“BFI” x=“70” y=“456” animation=“ ” />
        <Point name=“FSM” x=“142” y=“186” animation=“ ” />
        <Point name=“BSM” x=“88” y=“186” animation=“ ” />
        <Point name=“FLK” x=“147” y=“364” animation=“ ” />
        <Point name=“BLK” x=“76” y=“362” animation=“ ” />
        <Point name=“ET” x=“111” y=“155” animation=“ ” />
        <Point name=“BHT” x=“85” y=“144” animation=“ ” />
        <Point name=“HMB” x=“77” y=“153” animation=“ ” />
        <Point name=“FE” x=“107” y=“209” animation=“ ” />
      </PointCollection>
    </Stance>
  - <Stride frame=“45” rotation=“0” distance=“0”>
    - <PointCollection count=“2”>
        <Point name=“FFBSS” x=“221” y=“454” animation=“ ” />
        <Point name=“FFHIE” x=“257” y=“470” animation=“ ” />
      </PointCollection>
    </Stride>
  - <Load frame=“39” rotation=“0” distance=“0”>
      <PointCollection count=“0” />
    </Load>
  - <Pivot frame=“54” rotation=“0” distance=“0”>
      <PointCollection count=“0” />
    </Pivot>
    - <Visual frame=“52” rotation=“0” distance=“0”>
      <PointCollection count=“0” />
    </Visual>
  - <Trigger frame=“39” rotation=“0” distance=“0”>
    - <PointCollection count=“7”>
        <Point name=“HMB” x=“31” y=“249” animation=“ ” />
        <Point name=“BET” x=“56” y=“238” animation=“ ” />
        <Point name=“FE” x=“94” y=“263” animation=“ ” />
        <Point name=“FSM” x=“131” y=“214” animation=“ ” />
        <Point name=“BFT” x=“65” y=“458” animation=“ ” />
        <Point name=“FFT” x=“216” y=“452” animation=“ ” />
        <Point name=“DUMMY” x=“161” y=“366” animation=“ ” />
      </PointCollection>
    </Trigger>
  - <Stroke frame=“52” rotation=“0” distance=“0”>
    - <PointCollection count=“3”>
        <Point name=“HMB” x=“207” y=“206” animation=“ ” />
        <Point name=“BT” x=“96” y=“182” animation=“ ” />
        <Point name=“BHE” x=“227” y=“211” animation=“ ” />
      </PointCollection>
    </Stroke>
  - <Contact frame=“54” rotation=“0” distance=“0”>
    - <PointCollection count=“5”>
        <Point name=“BT” x=“291” y=“256” animation=“ ” />
        <Point name=“BK” x=“172” y=“226” animation=“ ” />
        <Point name=“MHC” x=“283” y=“219” animation=“ ” />
        <Point name=“BAC” x=“220” y=“240” animation=“ ” />
        <Point name=“BFC” x=“92” y=“432” animation=“ ” />
      </PointCollection>
    </Contact>
  - <Extension frame=“55” rotation=“0” distance=“0”>
    - <PointCollection count=“4”>
        <Point name=“BTE” x=“241” y=“209” animation=“ ” />
        <Point name=“FAE” x=“241” y=“209” animation=“ ” />
        <Point name=“TE” x=“221” y=“333” animation=“ ” />
        <Point name=“BFE” x=“753” y=“401” animation=“ ” />
      </PointCollection>
    </Extension>
  </TelestrationOutput>
```

We claim:

1. A system for creating a personal sports lesson, comprising:
a video capture module operable to receive transmission signals representing sports movement of a person and to present the transmission signals to a user as a plurality of still frames playable by the user, the video capture module further operable to receive input information from the user, the input information being used to process the plurality of still frames;
a training module operable to receive from the user a plurality of selected still frames from the plurality of still frames and a plurality of location coordinates on one or more of the plurality of selected still frames, the training module further operable to receive motion information about the selected still frames from the user, the training module performing sports analysis using the plurality of location coordinates and the motion information; and
a lesson module operable to provide an interactive sports lesson based on the sports analysis.

2. The system of claim 1, wherein the input information includes a new start still frame and the video capture module is operable to delete one or more still frames before the new start still frame.

3. The system of claim 1, wherein the input information includes a new ending still frame and the video capture module is operable to delete one or more still frames after the new ending still frame.

4. The system of claim 1, wherein the video capture module processes the plurality of still frames by de-interlacing one or more of the plurality of still frames.

5. The system of claim 1, wherein the video capture module processes the plurality of still frames by encoding the one or more of the plurality of still frames.

6. The system of claim 1, wherein the training module is further operable to include a graphic layer corresponding to each of the plurality of selected still frames, the graphic layer including the plurality of location coordinates.

7. The system of claim 6, wherein the training module is further operable to store the plurality of location coordinates and corresponding graphic layers in an XML format.

8. The system of claim 7, wherein the training wizard is further operable to compute a plurality of movements and position differences using the plurality of location coordinates corresponding to the plurality of selected still frames to perform sport analysis.

9. The system of claim 8, wherein the training wizard is further operable to compare the plurality of movements and position differences with data stored in a knowledge bank to perform sport analysis.

10. The system of claim 1, wherein the training module is operable to present a side-by-side view for guiding the user in inputting requested information.

11. The system of claim 1, wherein the lesson module includes at least an automatic lesson module and a swing module.

12. The system of claim 1, wherein the lesson module includes one or more pre-recorded drills on one or more positions in sports movement.

13. The system of claim 12, wherein the pre-recorded drills are performed by a professional player.

14. The system of claim 11, wherein the automatic lesson module is operable to present the sports analysis together with the one or more of the plurality of still frames.

15. The system of claim 14, wherein the automatic lesson module is further operable to present sports movements of a professional in a side-by-side relationship with the plurality of still frames.

16. The system of claim 15, wherein the professional is selected by the user.

17. The system of claim 15, wherein the automatic lesson module is further operable to present one or more telestration effects during presentation of the sports analysis.

18. The system of claim 15, wherein one or more of the plurality of still frames are played in sync with the sports movements of a professional player.

19. The system of claim 11, wherein the swing module is operable to present sports movements of a player in a side-by-side relationship with second sports movements in a synchronized manner.

20. The system of claim 19, wherein the second sports movements are those of a professional player of user's choice.

21. The system of claim 19, wherein the second sports movements are those of the player.

22. The system of claim 1, wherein the lesson module is further operable to present a report of the sports analysis.

23. The system of claim 1, wherein the video capture module is operable to receive the transmission signals from a remote device.

24. The system of claim 1, wherein the lesson module is further operable to allow the user to utilize telestration tools.

25. The system of claim 1, wherein the sports movement is a baseball swing.

26. A method for creating a personal sports lesson, comprising:
receiving transmission signals representing sports movements of a person;
presenting the transmission signals to a user as a plurality of still frames;
receiving a plurality of selected still frames from the plurality of still frames;
receiving one or more location coordinates in each of the plurality of selected still frames;
receiving motion information pertaining to the plurality of selected still frames; and
performing sports analysis based on the one or more location coordinates, the motion information, and pre-stored knowledge bank.

27. The method claim 26, wherein the receiving one or more location coordinates further includes allowing the user to mark one or more parts of the selected still frames and converting the one or more marked parts into the one or more location coordinates.

28. The method of claim 26, further including
providing an interactive lesson based on the sports analysis.

29. The method of claim 28, wherein the providing an interactive lesson includes:
presenting one or more of the plurality of still frames with audio analysis and telestrations.

30. The method of claim 29, further including presenting a side-by-side sports movement of a professional player illustrating the audio analysis.

31. The method of claim 28, further including presenting a report of the sports analysis.

32. The method of claim 28, further including presenting a side-by-side sports movements of a player and a professional player in a synchronized manner.

33. The method claim 28, further including presenting two side-by-side sports movements in a synchronized manner.

34. A program storage device readable by machine, tangibly embodying a program of instructions executable by the machine to perform a method of creating a personal sports lesson, comprising:
receiving transmission signals representing sports movements of a person;
presenting the transmission signals to a user as a plurality of still frames;
receiving a plurality of selected still frames from the plurality of still frames;
receiving one or more location coordinates in each of the plurality of selected still frames;
receiving motion information pertaining to the plurality of selected still frames; and
performing sports analysis based on the one or more location coordinates, the motion information, and pre-stored knowledge bank.

35. The storage device of claim 34, wherein the receiving one or more location coordinates further includes allowing the user to mark one or more parts of the selected still frames and converting the one or more marked parts into the one or more location coordinates.

36. The storage device claim 34, further including providing an interactive lesson based on the sports analysis.
